(19) United States
(12) Patent Application Publication
(10) Pub. No.: US 2004/0230979 A1
(43) Pub. Date: Nov. 18, 2004

(54) Command scheduling in computer networks

(75) Inventors: Jon Beecroft, Bristol (GB); David Hewson, Bristol (GB); Moray McLaren, Bristol (GB)

Correspondence Address: VOLPE AND KOENIG, P.C., UNITED PLAZA, SUITE 1600, 30 SOUTH 17TH STREET, PHILADELPHIA, PA, 19103, US

(73) Assignee: Quadrics Limited, Bristol (GB)

(21) Appl. No.: 10/714,696

(22) Filed: Nov. 17, 2003

(30) Foreign Application Priority Data
Nov. 18, 2002 (GB) 0226881.1

(51) Int. Cl. G06F 9/46

(52) U.S. Cl. 718/100

(57) ABSTRACT

A computer network (1) comprises:—at least two processing nodes each having a processor (4) on which one or more user processes are executed and a respective network interface (2); and a switching network (3) which operatively connects the at least two processing nodes together, each network interface (2) including a command processor and a memory wherein the command processor of said network interface (2) is configured to allocate exclusively to a user process being executed on the processor (4) with which the network interface (2) is associated one or more segments of addressable memory in said network interface memory as a respective one or more command queues The network interface (2) is capable of processing command data at high rates and with low latencies whilst maintaining the security of individual user processes.

The present invention relates to command scheduling in computer networks and to a network interface for use in the command scheduling method Moreover, the present invention is particularly, but not exclusively, suited for use in large-scale parallel processing networks.

With the increased demand for scalable system-area networks for cluster supercomputers, web-server farms, and network attached storage, the interconnection network and it's associated software libraries and hardware have become critical components in achieving high performance in modern computer systems. Key players in high-speed interconnects include Gigabit Ethernet (GigE)™, GigaNet™, SCI™, Myrinet™ and GSN™. These interconnect solutions differ from one another with respect to their architecture, programmability, scalability, performance, and ease of integration into large-scale systems. One factor which is critical to the performance of such interconnects is the management and in particular the scheduling of commands across the network.

With all computers multiple demands are made of both Its internal and peripheral resources and the scheduling of these multiple demands is a necessary procedure. In this respect each task to be executed is assigned to a queue where it is stored until the required resource becomes available at which point the task is removed from the queue to be processed. The same is true to a much greater extent with computer networks where are large number of individual tasks, each requiring data to be communicated across the network, are processed every second. How efficient the network is, depends upon Its latency and bandwidth. The lower the latency of the network and the wider the bandwidth, the better the network performance. Latency is a measure of the time period between the application of a stimulus (a request for connection in the network) and the first indication of a response from the network whereas the bandwidth of the network is a measure of its information carrying capacity. Most network communications are of inherently short duration, of the order of 5 milliseconds or less and the extent to which the duration of such network communications can be minimised is a factor in minimising the latency of the network as a whole.

U.S. Pat. No. 6,401,145 describes a system for improving the bandwidth of a network of processing nodes. Network requests are queued in the main memory of the processing node for asynchronous transmittal of data between the processing node and its network interface. Two queue-sets are used the first queue-set being dedicated to input data and the second queue-set being dedicated to output data. Queuing priorities both for the input and output queue-sets are also determined according to the importance of the data to be processed or transferred, and a queue description record is established. Data is then transferred to or received from the network interface according to the queuing priority.

In U.S. Pat. No. 6,141,701 a system for, and method of, off-loading message queuing facilities (“MQF”) from a mainframe computer to an intelligent input/output device are described. The intelligent I/O device includes a storage controller that has a processor and a memory. Stored in the storage controller memory is a communication stack for receiving and transmitting information to and from the mainframe computer. The storage controller receives I/O commands having corresponding addresses and determines whether the I/O command is within a first set of predetermined I/O commands. If so, the I/O command is mapped to a message queue verb and queue to invoke the MQF. From this, the MQF may cooperate with the communication stack in the storage controller memory to send and receive information corresponding to the verb.

The present invention seeks to provide an improved method of scheduling commands to be transmitted between the processing nodes of a network which is capable of improving the latency and bandwidth of the network in comparison to known computer networks. A representative environment for the present invention includes but is not limited to a large-scale parallel processing network.

In accordance with a first aspect of the present invention there is provided a computer network comprising:—at least two processing nodes each having a processor on which one or more user processes are executed and a respective network interface; and a switching network which operatively connects the at least two processing nodes together, each network interface including a command processor and a memory wherein the command processor of said network interface is configured to allocate exclusively to a user process being executed on the processor with which the network interface is associated one or more segments of addressable memory in said network interface memory as a respective one or more command queues

In accordance with a second aspect of the present invention there is provided a network interface comprising a command processor and a memory wherein the command processor of said network interface is configured to allocate exclusively to a user process being executed on a processor with which the network interface is associated, one or more segments of addressable memory in said network interface memory as a respective one or more command queues.

In accordance with a third aspect of the present invention there is provided a method of storing and running commands issued by a processor having associated with it a network interface comprising a command processor and a network interface memory, comprising the steps of: the network interface receiving a request for a command queue from a user process being executed on the processor; in response to the request allocating exclusively to the user process a memory segment of the network interface memory as a command queue; storing one or more commands associated with the user process in said command queue; and running said commands in said command queue without further intervention from said processor.

With the present invention, command queues are stored in and actioned from the network interface memory without further intervention from the processor. This is possible as each memory region allocated as a command queue is exclusively assigned to a particular user process being executed by the processor and so the commands issued by that user process to the network interface are stored in a command queue specific to that user process. In this way the network interface is capable of processing command data at rates approaching 1 Gbytes/S and delivering latencies from the PCI bus to the network interface of less than 100 nS whilst still maintaining the security of the individual user processes.

An embodiment of the present invention will now be described, by way of example only, with reference to the accompanying drawings in which:

FIG. 1 is a schematic diagram of a computer network;

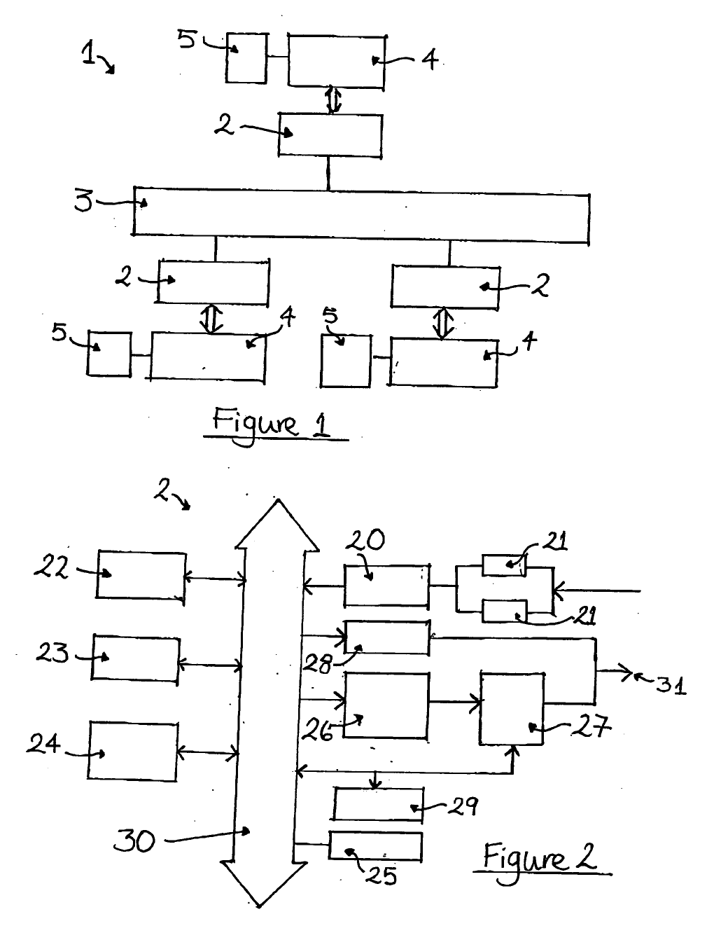

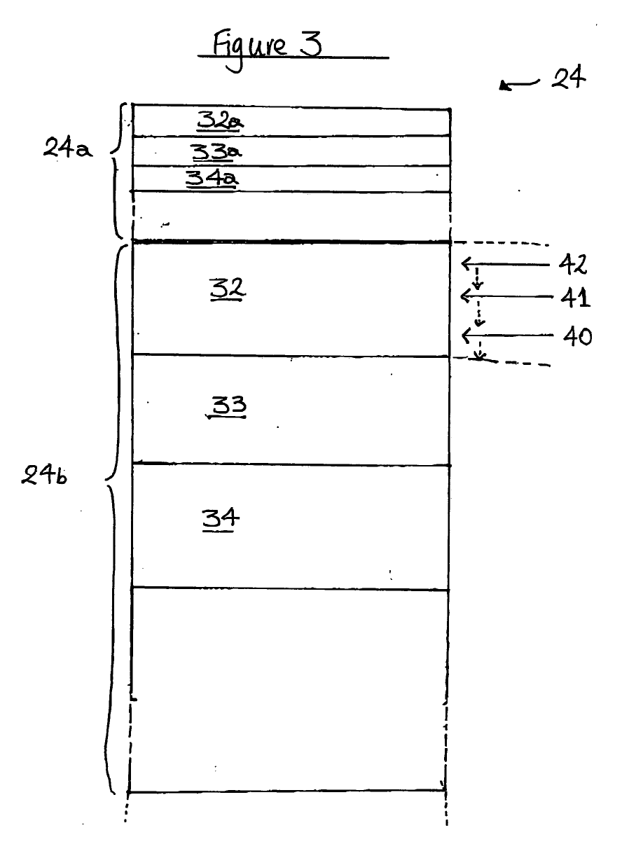

FIG. 2 illustrates the functional units of a network interface of the computer network in accordance with the present invention; and

FIG. 3 illustrates the allocation of memory space in the network interface SDRAM in accordance with the present invention and three command queue pointers used in the command queues of the network interface.

FIG. 1 illustrates a computer network 1 which includes a plurality of separate processing nodes connected across a switching network 3. Each processing node may comprise one or more processors 4 each having its own memory 5 and a respective network interface 2 with which the one or more processors 4 communicate across a data communications bus.

The computer network 1 described above is suitable for use in parallel processing systems. Each of the individual processors 4 may be, for example, a server processor such as a Compaq ES45. In a large parallel processing system, for example, forty or more individual processors may be interconnected with each other and with other peripherals such as, but not limited to, printers and scanners.

As illustrated in FIG. 2, the network interface 2 has an input buffer 20 that receives data from the network via paired virtual first-in-first out (FIFO) channels 21. In addition, the network interface 2 includes, but is not limited to, the following functional units which will be described in greater detail below: a memory management unit (MMU) 22, a cache 23, a memory 24 preferably SDRAM, a thread processor 25, a command processor 26, a short transaction engine (STEN) 27 and a DMA engine 28 and a scheduler 29. Both the STEN 27 and the DMA engine 28 are in data communication with the network interface output 31 to the switching network 3. The command processor 26 accepts ordered write data from any source. This includes burst PIO writes from the processor 4; local writes from the thread processor 25; burst writes from a network interface event that has just fired; write data directly from the network; and even data written directly from another command queue. The command processor 26 is used to control the STEN processor 27, the DMA processor 28, and the thread processor 25. It is also used to generate user interrupts to the processor 4 in order, for example, to copy small amounts of data, to write control words and to adjust network cookies. Each of the functional units of the network interface 2 referred to above is preferably interconnected using many separate 64 bit data buses 30. This use of separate paths increases concurrency and reduces data transfer latency.

The network interface 2 provides data communications and control synchronisation mechanisms that can be used directly from a client program. That is to say, the individual client programs run on the respective processor 4 with which the network interface 2 is connected, are able to issue commands via the network interface 2 directly to the network 1 as opposed to all such commands being processed via the operating system of the processor 4. These mechanisms are based upon the network interface's ability to transfer information directly between the address spaces of groups of cooperating processes, across the network, whilst maintaining hardware protection between the process groups.

Each client program process, herein referred to as a user process, is assigned a context value that determines the physical addresses it is permitted to access on the network interface (described in detail below). Furthermore, the context value also identifies which remote processes may be communicated with over the network and where the processes reside (i.e. at other processing nodes). Through the use of pre-assigned address spaces the security of the network and the protection between process groups is maintained by the network interface 2. In this respect, it should be noted that the user processes do not have direct access to their context values, it is the network interface 2 that manipulates the context values on behalf of the user processes.

In the case of a program being run in parallel by more than one processing node on the network 1, the individual processes that makeup the program are assigned to their respective processing nodes and each process is allocated a virtual process identification number through which it can be addressed by the other processes in the program. The routing details for the program is then determined and a virtual process table is initialised for each context. A virtual process table is maintained by the network interface 2 for each process and contains an entry for each user process that makes up the parallel program indexed by their virtual process identification number. The virtual process table includes context values to be used for remote operations to be carried out at remote processing nodes which are hosting the relevant virtual process and routing information needed to send a message from the local processing node to the other remote processing nodes hosting the same virtual process.

Each user process is assigned exclusive rights to one or more virtual memory segments in the SDRAM 24 of the network interface and has its own set of one or more command queues which are mapped by the network interface into the pre-assigned virtual address space of the process using the relevant context. Thus, as schematically Illustrated in FIG. 3, a first part of the addressable space of the SDRAM 24 is allocated to storing command queue descriptors 24a and a second part 24b of the SDRAM addressable space is allocated to storing the command queues. With respect to the second part 24b of the SDRAM separate contiguous SDRAM address spaces are allocated to each command queue, three 32, 33, 34 are Illustrated in FIG. 3: The first command queue 32 is a single command queue for a first user process which separately has a command queue descriptor 32a mapped to a command port. The second and third command queues 33 and 34 are separate command queues for a second user process and have respective command queue descriptors 33a and 34a.

The command queue for each user process provides the user process with a set of virtual resources including a DMA engine, a STEN, a thread processor and interrupt logic. Through the pre-assignment of virtual address space by the network interface in the manner described above, the security of the individual programs being processed by the processor 4 is maintained without the need to invoke a system call. This ability to circumvent the operating system of the processor 4 enables the latency of the network interface's operations to be significantly reduced.

The command queues enable user processes executing on the processor 4 to write packets directly to the network 1. For example, short packets of up to 31 transactions, with each transaction being up to 32 64 bit words long, can be sent through the command queue mechanism. The packets are typically for control purposes or very low latency transfers of small quantities of data rather than the transfer of bulk data, which is transferred more efficiently using DMA. As mentioned above, each command queue is represented by a 32 byte queue descriptor also held in the SDRAM 24. 8 Kbytes of contiguous SDRAM is preferably reserved for the queue descriptors. Entries in a command queue are commands represented by one or more 64 bit values. The shortest commands may be represented by one 64 bit word whereas the longest may be represented by a whole packet with many transactions. The commands issued by a user process contain sufficient control information for the command processor to carry out retries and conditional processing on behalf of the user process. This means that the user process can write a sequence of packets to the command queue without waiting for one to be acknowledged before sending the next.

From the perspective of the user process, the command queues are virtual resources in the form of blocks of write-only memory. The user process makes a system call to request a queue of a specified depth and as the assignment of the command queue by the network interface 2 arises from a system call, access to the queue is protected. Once the command queue is allocated, the management of the queue becomes the responsibility of the user process. Where the algorithms of a user process have a natural limit to the maximum quantity of outstanding work that is issued to the queue, flow control through the assigned command queue can be controlled by the user process always ensuring that work previously queued is completed before new work is issued. If the maximum amount of work cannot be calculated, then the user process may insert a guarded write of a control word to the memory space into the command stream at regular intervals. Whichever procedure is adopted by the user process to avoid overfilling the command queue, if an overflow occurs, an error bit in the command queue descriptor is set, the command queue traps and the relevant user process is signalled.

From a system perspective, an 8 Kbyte array of command ports is mapped into the PCI address space. Each command port appears in the user address space as an 8 Kbyte page and is mapped into one TLB entry of the main processor's MMU. To allocate a queue to a user process, a queue descriptor is mapped to a command port, a block of SDRAM of the requested size is reserved to the queue data and the user process is given privilege to write to the command port.

The network interface driver can directly access the queue descriptor and queue data in the SDRAM 24 and when a user process write a command to their allocated command queue, the command is written directly to the SDRAM, bypassing the cache 23.

Using the scheduler 29, the command processor 26 schedules the command queues and preferably maintains a plurality of separate run queues, for example one high priority run queue and one low priority run queue. Command queues that are neither empty nor being executed by the command processor are added to one of these run queues. The command processor preferably has a ‘head of queue’ cache of 128 64 bit words and a 16 entry queue descriptor cache which is dedicated to the queue pointers (described below). This allows separate processors on a SMP node to write commands simultaneously to the network interface over a PCI bus without significant queue rescheduling overhead.

Each command queue is managed by three pointers and each pointer is manipulated by a separate process running in the command processor 26. The pointers are illustrated in FIG. 3 with respect to the command queue 32.

The insert pointer 40 points to the back of the command queue where new entries are to be inserted When it reaches the end of the memory space allocated for that queue, it wraps around to point to the start of the memory space. The insert pointer 40 is managed by an inserter process which receives command writes and send them to the command queue. The inserter process writes the commands to incrementing addresses and after writing a command to the queue it updates the insert pointer by the size of the command. The inserter process is only sensitive to the order in which data is supplied to it; it does not use the write address to index into the queue. The queue index is supplied solely in the queue descriptor by the insert pointer.

The completed pointer 42 is the true front of the queue. It is only moved on when a command sequence has completed. This means that the sequence cannot be executed again should an error, trap or network discard take place. Many separate commands may be required in a command sequence (for example Open STEN Packet, Send Transaction, Send Transaction, . . . is the command sequence for a packet for the STEN processor). When a command sequence has completed successfully, the completed pointer is incremented by the size of that command sequence. What constitutes the successful completion of a command is defined by the command itself. Additional support can be provided specifically for generating packets for the STEN processor 27.

The extract pointer 41 is a temporary value that is loaded from the completed pointer 42 every time a command queue is rescheduled. It points to the command value most recently removed from the queue by the command processor's extractor processes. The extract pointer 41 is incremented by one for each value taken from the queue. If a command fails, the extractor process is descheduled and the command queue is put back onto the run queue. When the queue is rescheduled, the extract pointer is reloaded from the completed pointer.

As mentioned earlier a command queue descriptor is generated and stored in SDRAM which contains all the state required to manage the progress of the queue. The fields of the command queue descriptor preferably include the following:

Error bit. This bit becomes set if the insert pointer advances past the completed pointer, i.e. queue overflow. When this bit is set, it will cause a trap.

Priority bit. When this bit is set, for a particular queue, the queue will run with a higher priority than the queues without this bit set.

Size. This bit denotes the size of the queue which is preferably restricted to a set of permissible predetermined sizes for example: 1 Kbytes, 8 Kbytes, 64 Kbytes or 512 Kbytes.

Trapped bit. This will be set if a command being executed traps. The processing node issuing the command then stops all execution of commands until the trap state has been extracted. This means that when the processing node issuing the commands is restarted, the command queue is dropped from the run queue and this bit is then cleared.

Insert pointer. As mentioned above, this is the pointer to the back of the command queue where command data is to be inserted into the queue.

Completed pointer. As mentioned earlier, this is the pointer to the front of the command queue. It is only moved on when the operation is guaranteed to be complete. It is not necessarily the pointer to the place the queue is being read from—this is the Extract pointer as described below.

Restart count bit. This bit is reduced every time the current pointer is reset to the completed pointer. Each time this bit is reduced, it will cause the queue to be descheduled and another queue scheduled. When it reaches zero, it will also cause the queue to trap.

Channel not completed bit. This is set when the last transaction of a packet is executed. It is cleared when the completer process moves the completed process moves the completed pointer over the packet. It is used to determine whether a packet is to be retransmitted.

Packet Acknowledgement bit. This 4 bit acknowledgement provides the queue packet status.

Context. As described earlier, these bits provide a context for all virtual memory and virtual process references.

The extract process has additional state information that is created from the queue descriptor when a new command queue is scheduled for execution. This state is then discarded when the queue is descheduled. The additional state information preferably includes:

Extract Pointer. As mentioned earlier, this pointer points to the current command being executed. When a command queue is scheduled for draining, the Extract pointer is loaded from the Completed pointer.

Prefetch Pointer. This bit can be used to prefetch ahead new commands if the queue data is being read from th SDRAM.

The command type is preferably encoded in the bottom bits of the first 64 bit value inserted into the command queue with th top bits being retained for command data. The command types include but are not limited to Run Thread, Open STEN Packet, Send Transaction, WriteDWord, Copy64 bytes, Interrupt, Run DMA. Thus, with the command type Run Thread higher level, message passing libraries can be implemented without the explicit intervention of the processor 4. The thread processor 25 can be used for single cycle load and store operations. It is closely coupled to the cache 23 which it uses as a data store. Also, the command type Open STEN enables short packets to be transmitted into the network 1 by means of the STEN processor 27. The STEN processor 27 is particularly optimised for short read and writes and for protocol control. Preferably, the STEN processor 27 is arranged to handle two outstanding packets for each command queue with the packets it issues being pipelined to provide very low latencies. Similarly, the command type Run DMA enables remote read/write memory operations via the DMA engine 28.

As can be seen from the above, the network interface described above and in particular the allocation of separate command queues for each user process greatly improves the latency of the computer network as it enables the intervention of the processor 4 to be avoided for individual operations. The present invention is particularly suited to implementation in areas such as weather prediction, aerospace design and gas and oil exploration where high performance computing technology is required to solve the complex computations employed.

The present invention is not limited to the particular features of the network interface described above or to the features of the computer network as described. Elements of the network interface may be omitted or altered, and the scope of the invention is to be understood from the appended claims. It is noted in passing that an alternative application of the network interface is in large communications switching systems.

1. A computer network comprising:—at least two processing nodes each having a processor on which one or more user processes are executed and a respective network interface; and a switching network which operatively connects the at least two processing nodes together, each network interface including a command processor and a memory wherein the command processor of said network interface is configured to allocate exclusively to a user process being executed on the processor with which the network interface is associated one or more segments of addressable memory in said network interface memory as a respective one or more command queues.

2. A computer network as claimed in claim 1, wherein each one of said memory segments allocated as command queues is a contiguous series of memory addresses.

3. A computer network as claimed in claim 1, wherein each memory segment of the network interface memory allocated as a command queue has associated with it a queue descriptor which includes a user process identification.

4. A computer network as claimed in claim 3, wherein each queue descriptor includes an insert pointer identifying within the allocated memory segment the memory address where new commands from the relevant user process are to be written.

5. A computer network as claimed in claim 3, wherein each queue descriptor includes a completed pointer identifying within the allocated memory segment the memory address of the end of the most recent completed command.

6. A computer network as claimed in claim 1, wherein the network interface includes a scheduler configured to Identify and schedule any active command queues in th network interface memory.

7. A computer network as claimed in claim 6, wherein the scheduler has two or more run queues with at least on of the run queues being denominated a high priority run queue and at least one other of the run queues being denominated a low priority queue.

8. A computer network as claimed in claim 1, wherein said network interface includes at least one of the following resources: a thread processor, short transaction engine and a DMA engine, and each command queue stored in said network interface memory has associated with it a corresponding one or more virtual resources.

9. A network interface comprising a command processor and a memory wherein the command processor of said network interface is configured to allocate exclusively to a user process being executed on a processor with which the network interface is associated, one or more segments of addressable memory in said network interface memory as a respective one or more command queues.

10. A network interface as claimed in claim 9, wherein each one of said memory segments allocated as command queues is a contiguous series of memory addresses.

11. A network interface as claimed either in claim 9, wherein each memory segment of the network interface memory allocated as a command queue has associated with it a queue descriptor which includes a user process identification.

12. A network interface as claimed in claim 11, wherein each queue descriptor includes an insert pointer identifying within the allocated memory segment the memory address where new commands from the relevant user process are to be written.

13. A network interface as claimed in claim 11, wherein each queue descriptor includes a completed pointer identifying within the allocated memory segment the memory address of the end of the most recent completed command.

14. A network interface as claimed in claim 9, wherein the network interface includes a scheduler configured to identify and schedule any active command queues in the network interface memory.

15. A network interface as claimed in claim 14, wherein the scheduler has two or more run queues with at least one of the run queues being denominated a high priority run queue and at least one other of the run queues being denominated a low priority queue.

16. A network interface as claimed in claim 9, wherein said network interface includes at least one of the following resources: a thread processor, short transaction engine and a DMA engine, and each command queue stored in said network interface memory has associated with it a corresponding one or more virtual resources.

17. A method of storing and running commands issued by a processor having associated with it a network interface comprising a command processor and a network interface memory, comprising the steps of:
the network interface receiving a request for a command queue from a user process being executed on the processor;
in response to the request allocating exclusively to the user process a memory segment of the network interface memory as a command queue;
storing one or more commands associated with the user process in said command queue; and
running said commands in said command queue without further intervention from said processor.

18. A method as claimed in claim 17, wherein in response to requests from a plurality of user processes being executed on the processor, a respective plurality of memory segments of the network interface memory are allocated by the network processor.

19. A method as claimed in claim 17, further comprising the step of said network processor generating a queue descriptor, which includes a user process identification, for each allocated memory segment.

20. A method as claimed in claim 17, wherein said network interface includes a scheduler and said method further comprises the step of generating a run queue of active command queues in said network interface memory each active command queue containing at least one command awaiting execution.

21. A method as claimed in claim 20, wherein at least two run queues are generated including a high priority run queue and a low priority run queue.
